(19) United States
(12) Patent Application Publication
(10) Pub. No.: US 2026/0176426 A1
(43) Pub. Date: Jun. 25, 2026

(54) TREATING LEATHER WITH SILICONE - (METH)ACRYLATE COPOLYMER EMULSION TO IMPART STAIN RESISTANCE AND OIL REPELLENCY

(71) Applicant: Dow Silicones Corporation, Midland, MI (US)

(72) Inventors: Jacob Milne, Hemlock, MI (US); Matthew Jeletic, Freeland, MI (US); Jodi Mecca, Midland, MI (US); Bertrand Louis Lenoble, Silly (BE); Padmadas Nair, Seneffe (BE); Douglas Hasso, Auburn, MI (US); Anirudha Banerjee, Saginaw, MI (US); Devin Ferguson, Midland, MI (US); Brian Macdonald, Midland, MI (US)

(21) Appl. No.: 19/539,168

(22) Filed: Feb. 13, 2026

Related U.S. Application Data
(63) Continuation-in-part of application No. PCT/US2024/052892, filed on Oct. 25, 2024.
Application No. PCT/US2024/052892 is a continuation-in-part of application No. PCT/US2024/045245, filed on Sep. 5, 2024.
(60) Provisional application No. 63/593,716, filed on Oct. 27, 2023.
(60) Provisional application No. 63/674,322, filed on Jul. 23, 2024.

(51) Int. Cl. C08G 77/50; C08F 220/06

(52) U.S. Cl. CPC C08G 77/50; C08F 220/06

(57) ABSTRACT

A method for treating leather to impart stain and oil repellency employs a composition including a silicone-(meth)acrylate copolymer. The leather treatment composition is an aqueous emulsion suitable for use on crust leather and base-coated leather. The method and composition that may further include a silicone polyether to improve coating uniformity, particularly when the method will be used to prepare a topcoat on base-coated leather. The leather treatment composition is PFAS-free.

### CROSS-REFERENCE TO RELATED APPLICATIONS

This application is a continuation in part of PCT Application Serial Number PCT/US24/052892 filed on 25 Oct. 2024, currently pending, which was published under PCT Article 21 (2) in English, and which application claims priority under 35 USC § 119 (e) to U.S. Provisional Patent Application No. 63/593,716 filed on 27 Oct. 2023 and U.S. Provisional Patent Application No. 63/674,322 filed on 23 Jul. 2024; and this application further claims the benefit of PCT Application Serial Number PCT/US24/045245 filed on 5 Sep. 2024. All of U.S. Provisional Patent Application No. 63/593,716, U.S. Provisional Patent Application No. 63/674,322, PCT Application Serial Number PCT/US24/045245, and PCT Application Serial Number PCT/US24/052892 are hereby incorporated by reference.

### FIELD

A leather treatment composition and methods for preparation and use thereof are provided. More specifically, the leather treatment composition is an aqueous emulsion or dispersion including a silicone-(meth)acrylate copolymer. The leather treatment composition is useful to impart stain resistance and oil repellency to leather substrates.

### INTRODUCTION

Fluorinated materials have been utilized on leather as stain repellents. These were mostly based on perfluoroalkyl substances (PFAS) diluted in various solvents; however, customers and regulatory pressures are contributing to an industry need for non-fluorocarbon-based leather treatments. Finding an alternative to these PFAS materials, specifically for stain and oil repellency, that is durable and high performing would be desirable to various industries such as automotive OEM, upholstery makers, and fashion brands.

### SUMMARY

A process for treating leather comprises: I) applying to a surface of a leather substrate, a leather treatment composition comprising a silicone-(meth)acrylate copolymer, a nonionic surfactant, and water; and II) drying the substrate.

### DETAILED DESCRIPTION

The silicone-(meth)acrylate copolymer, introduced above, comprises unit formula:

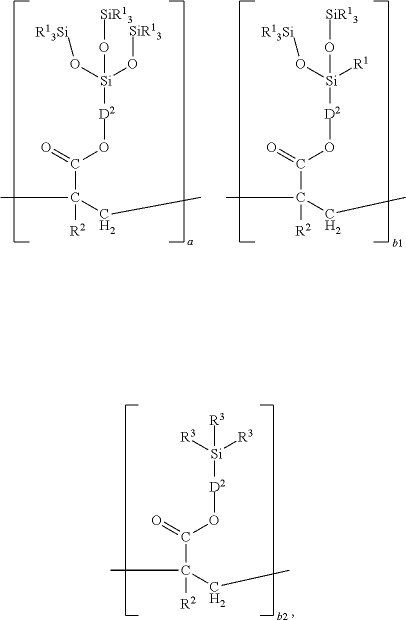

where each R¹ is an independently selected monovalent hydrocarbon group of 1 to 12 carbon atoms; each D² is an independently selected divalent hydrocarbon group of 2 to 12 carbon atoms; and each R² is independently selected from the group consisting of H and methyl; each R³ is a group of formula OSi(R⁴)₃; where each R⁴ is independently selected from the group consisting of R and DSi(R⁵)₃, where each R is an independently selected monovalent hydrocarbon group of 1 to 12 carbon atoms, and each D is independently selected from the group consisting of an oxygen atom, a (poly)alkylene oxide group of 1 to 12 units, and a divalent hydrocarbon group of 2 to 4 carbon atoms; each R⁵ is independently selected from the group consisting of R and DSi(R⁶)₃; where each R⁶ is independently selected from the group consisting of R and DSiR₃; with the proviso that R⁴, R⁵, and R⁶ are selected such that the silicone-(meth)acrylate co-macromonomer unit with subscript b2 has at least 5 silicon atoms; subscripts a, b1, and b2 represent weight fractions of units in the copolymer, and subscripts a, b1, and b2 have values such that 0.25<a≤1; and 0≤(b1+b2)<0.75.

One skilled in the art would recognize that the silicone-(meth)acrylate copolymer (copolymer) introduced above may be prepared by radical polymerization, via a method as described below, and that this method would form a terminal moiety for the copolymer. The copolymer with the unit formula above further comprises a terminal moiety which may be derived from an initiator, a chain transfer agent, or both, as described, for example in Odian, George (2004). Principles of Polymerization (4th ed.). New York: Wiley-Interscience. ISBN 978-0-471-27400-1.

The copolymer may be prepared via a method comprising: 1) copolymerizing starting materials comprising
(A) a silicone-(meth)acrylate macromonomer of formula

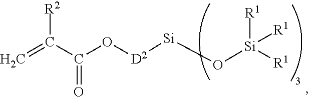

where each R¹ is an independently selected monovalent hydrocarbon group of 1 to 12 carbon atoms; D² is a divalent hydrocarbon group of 2 to 12 carbon atoms; and R² is selected from the group consisting of H and methyl;
optionally (B) a silicone-(meth)acrylate co-macromonomer, wherein (B) the silicone-(meth)acrylate co-macromonomer has a formula selected from the group consisting of formula (B-1), formula (B-2), and a combination of both formula (B-1) and formula (B-2), wherein
   formula (B-1) is

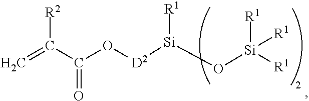

where each R¹ is an independently selected monovalent hydrocarbon group of 1 to 12 carbon atoms; D² is a divalent hydrocarbon group of 2 to 12 carbon atoms; and R² is selected from the group consisting of H and methyl;
formula (B-2) is

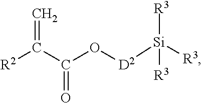

where R² is selected from the group consisting of H and methyl; D² is a divalent hydrocarbon group of 2 to 12 carbon atoms, and each R³ is a group of formula OSi(R⁴)₃; where each R⁴ is independently selected from the group consisting of R and DSi(R⁵)₃, where each R is an independently selected monovalent hydrocarbon group of 1 to 12 carbon atoms, and each D is independently selected from the group consisting of an oxygen atom, a (poly)alkylene oxide group of 1 to 12 units, and a divalent hydrocarbon group of 2 to 4 carbon atoms; each R⁵ is independently selected from the group consisting of R and DSi(R⁶)₃; where each R⁶ is independently selected from the group consisting of R and DSiR₃; with the proviso that R⁴, R⁵, and R⁶ are selected such that the silicone-(meth)acrylate co-macromonomer of formula (B-2) has at least 5 silicon atoms per molecule;
wherein starting material (A) is present in an amount of >25 weight % to 100 weight %, based on combined weights of starting materials (A) and (B); and wherein starting material (B) is present in an amount of 0 to <75 weight %, based on combined weights of starting materials (A) and (B); and wherein starting materials (A) and (B) are copolymerized in the presence of an additional starting material, wherein the additional starting material comprises (C) an initiator. The additional starting material used in step 1) may optionally further comprise one or more of (H) a chain transfer agent; (I) a manganese ion source; (J) a phenolic compound; and a chelating agent.

Step 1) of the method may comprise an emulsion polymerization reaction. The additional starting materials further comprise (D) a surfactant and (E) water. In step 1), the emulsion polymerization described above may comprise forming an emulsion comprising starting material (A) the silicone-(meth)acrylate macromonomer, (B) the silicone-(meth)acrylate co-macromonomer (when present), (D) the surfactant, (E) water, and optionally one or more of (H) the chain transfer agent, (I) the manganese ion source, and (J) the phenolic compound and thereafter adding (C) the initiator and copolymerizing. Without wishing to be bound by theory, it is thought that during processing to combine and emulsify (A) the silicone-(meth)acrylate macromonomer, (B) the silicone-(meth)acrylate co-macromonomer, (D) the surfactant, and (E) the water, and when present (H) the chain transfer agent, then starting materials (I) the manganese ion source and/or (J) the phenolic compound may inhibit formation of acrylic radicals that can impact the formation of the copolymer during copolymerization in step 1).

Step 1) of the method described above may comprise forming an emulsion comprising starting materials (A) the silicone-(meth)acrylate macromonomer, (B) the silicone-(meth)acrylate co-macromonomer, (C) the initiator, (D) the surfactant, and (E) the water, and optionally an additional starting material selected from the group consisting of (H) the chain transfer agent, (I) the manganese ion source, (J) the phenolic compound, and a combination of two or more thereof. These starting materials may be mixed under shear to form the aqueous emulsion. Mixing under shear may be performed by any convenient means for forming an aqueous emulsion, such as sonication and with subsequent microfluidization. Equipment for mixing under shear, such as sonicators, homogenizers, microfluidizers, and speedmixers are known in the art and are commercially available. Without wishing to be bound by theory, it is thought that mixing under shear may be used to obtain a submicron particle size in the emulsion. In step 1), starting materials comprising (A) the silicone-(meth)acrylate macromonomer, (B) the silicone-(meth)acrylate co-macromonomer, (C) the initiator (and when present (H) the chain transfer agent) copolymerize to form (F) the silicone-(meth)acrylate copolymer in the aqueous emulsion with starting materials (D) the surfactant and (E) the water, and optionally (I) manganese ion source and (J) the phenolic compound.

The method described herein may optionally further comprise one or more additional steps. For example, before step 1) the starting materials comprising (A) the silicone-(meth)acrylate macromonomer and (B) the silicone-(meth)acrylate co-macromonomer, and when present (H) the chain transfer agent may be combined under aerobic or anaerobic conditions, optionally with heating for extended times. For example, the starting materials comprising (A) the silicone-(meth)acrylate macromonomer and (B) the silicone-(meth)acrylate co-macromonomer, and when present one or more of (H) the chain transfer agent, (I) manganese ion source, and/or (J) the phenolic compound, may be emulsified with (D) the surfactant and (E) the water before adding (C) the initiator and copolymerizing in step 1). In step 1), combining the starting materials and copolymerizing in the method described above may be performed on a commercial scale under anaerobic or aerobic conditions optionally at elevated temperature, e.g., up to 100° C., alternatively 40° C. to 80° C., and alternatively 45° C. to 50° C. Copolymerizing may be performed in a batch process with a residence time of 15 minutes to 24 hours, alternatively 30 minutes to 12 hours, alternatively 40 minutes to 8 hours, and alternatively 40 minutes to 2 hours. For purposes of this application, aerobic or anaerobic conditions means that oxygen is not required to be present in the gas in the headspace of the reactor where copolymerizing takes place, or dissolved in the liquid where copolymerizing takes place. The balance of the gas in the headspace could be an inert gas such as nitrogen or argon.

Alternatively, the copolymer described above may be prepared by a method comprising dissolving one or more of the starting materials, such as (A) the silicone-(meth)acrylate macromonomer, and optionally one or more of (B) the silicone-(meth)acrylate co-macromonomer, (H) the chain transfer agent, (I) the manganese ion source, and (J) the phenolic compound, in an organic solvent (such as a monohydric alcohol) and copolymerizing starting material (A) the silicone-(meth)acrylate macromonomer, and when present (B) the silicone-(meth)acrylate co-macromonomer, and/or (H) the chain transfer agent in a method such as that disclosed in U.S. Pat. No. 10,047,199 to limura, et al. by varying appropriate starting materials and their amounts. The resulting copolymer may be solvent borne. All or a portion of the solvent may be removed by any convenient means, such as by stripping or distillation with heat and optionally reduced pressure. The resulting copolymer may be emulsified using (D) the surfactant and (E) the water.

Regardless of the method used to make the copolymer, e.g., either via emulsion polymerization or by emulsifying the solvent borne copolymer (after solvent removal), the product prepared in step 1) is an aqueous emulsion comprising (F) the silicone-(meth)acrylate copolymer, (D) the surfactant, and (E) the water. The aqueous emulsion may optionally further comprise (I) the manganese ion source and/or (J) the phenolic compound. This aqueous emulsion can be used as the leather treatment composition. Alternatively, this aqueous emulsion may be used to prepare the leather treatment composition, by a process comprising practicing step 1) as described above, thereby preparing the aqueous emulsion, and 2) combining the aqueous emulsion prepared in step 1) and an additional starting material comprising (G) a silicone polyether. Step 2) may optionally further comprise adding a further additional starting material, which may be selected from the group consisting of (K) a biocide, (L) additional water (which may be the same as starting material (E)), (M) a solvent (to reduce viscosity and improve coalescence of the binder particles), (N) a matting additive (e.g., silica), (O) a rheology modifier, (Q) a softening additive, and a combination of two or more thereof. Step 2) of this method may optionally further comprise adding additional (D) surfactant. Additional starting materials may be as described for example, in U.S. Pat. Nos. 9,200,404, 10,100,377, and 11,518,905.

Step 2) of the process described above for making the leather treatment composition may be performed by any convenient means, such as mixing using a jacketed vessel equipped with an agitator. Step 1) and step 2), and any optional and/or additional steps as described above may be performed sequentially in the same vessel. Alternatively, step 1) and step 2) may be performed in different equipment. Step 2) may be performed at RT or elevated temperature, e.g., up to 100° C., alternatively 40° C. to 80° C. Alternatively, heating may be performed in step 1), and step 2) may be performed at RT. Alternatively, step 2) may be performed at lower temperatures and elevated pressures, such as up to 5 atmospheres. The starting materials used in the method described above are further described below.

Starting material (A) used herein is a silicone-(meth)acrylate macromonomer. The silicone-(meth)acrylate macromonomer has formula (A-1):

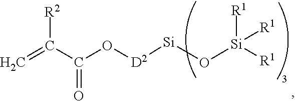

where each R¹ is an independently selected monovalent hydrocarbon group of 1 to 12 carbon atoms; D² is a divalent hydrocarbon group of 2 to 12 carbon atoms; and R² is selected from the group consisting of H and methyl.

In formula (A-1), each R¹ is an independently selected monovalent hydrocarbon group of 1 to 12 carbon atoms. The monovalent hydrocarbon group for R¹ may be an alkyl group, such as an alkyl group of 1 to 6 carbon atoms. Alternatively, the alkyl groups may have 1 to 3 carbon atoms, alternatively 1 to 2 carbon atoms. Alternatively, each R¹ group may be methyl.

In formula (A-1), D² is a divalent hydrocarbon group of 2 to 12 carbon atoms. Alternatively, D² may have 2 to 10, alternatively 3 to 5, and alternatively 3 carbon atoms. The divalent hydrocarbon group for D² may be exemplified by an alkylene group such as ethylene, propylene, or butylene. Alternatively, the divalent hydrocarbon group for D² may be propylene. Alternatively, D² may be linear, e.g., —(CH₂)₂— or —(CH₂)₃—. Alternatively, D² may be —(CH₂)₃—. Alternatively, when D² comprises —(CH₂)₃—, starting material (A) comprises formula (A-2):

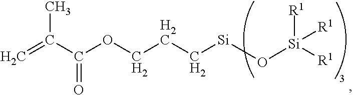

where R¹ is as described above.

Starting material (A) may comprise 3-(1,1,1,5,5,5-hexamethyl-3-((trimethylsilyl)oxy)trisiloxan-3-yl)propyl methacrylate of formula

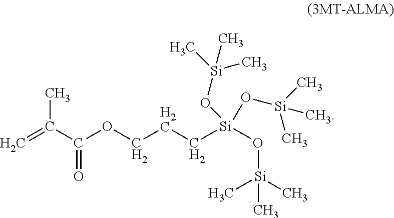 [SMILES: C=C(C)C(=O)OCCC[Si](O[Si](C)(C)C)(O[Si](C)(C)C)O[Si](C)(C)C]

Starting material (A) may be prepared by known methods, such as those disclosed in PCT Publication WO2020142388 and U.S. Pat. No. 6,420,504. The amount of starting material (A) may be 23% to 35%, based on combined weights of starting materials (A), (B), (C), (D), and (E) used in emulsion polymerization.

Starting material (B) is a silicone-(meth)acrylate co-macromonomer (co-macromonomer) that may optionally be copolymerized with (A) the silicone-(meth)acrylate macromonomer described above. Starting material (B), the co-macromonomer, may comprise formula (B-1), where formula (B-1) is where

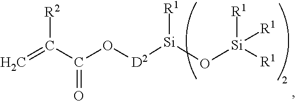

each R¹ is an independently selected monovalent hydrocarbon group of 1 to 12 carbon atoms; D² is a divalent hydrocarbon group of 2 to 12 carbon atoms; and R² is selected from the group consisting of H and methyl, each as described and exemplified above for formula (A-1). Alternatively, when D² comprises —(CH₂)₃—, formula (B-1) may comprise:

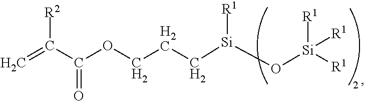

where R¹ and R² are as described above. Alternatively, formula (B-2) may comprise 3-(1,1,1,3,5,5,5-heptamethyltrisiloxan-3-yl)propyl methacrylate of formula

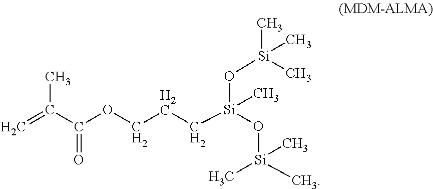 [SMILES: C=C(C)C(=O)OCCC[Si](C)(O[Si](C)(C)C)O[Si](C)(C)C]

Alternatively, in addition to, or instead of, formula (B-1) shown above, starting material (B) the co-macromonomer may comprise a silicone-(meth)acrylate co-macromonomer of formula (B-2):

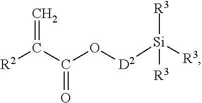

where D² is a divalent hydrocarbon group of 2 to 12 carbon atoms; and R² is selected from the group consisting of H and methyl, each as described above for formula (A-1). In formula (B-2), each R³ is a group of formula OSi(R⁴)₃; each R⁴ is independently selected from the group consisting of R and DSi(R⁵)₃, where each R is an independently selected monovalent hydrocarbon group of 1 to 12 carbon atoms; each D is independently selected from the group consisting of an oxygen atom, a (poly)alkylene oxide group of 1 to 12 units, and a divalent hydrocarbon group of 2 to 4 carbon atoms; each R⁵ is independently selected from the group consisting of R and DSi(R⁶)₃; where each R⁶ is independently selected from the group consisting of R and DSiR₃; with the proviso that R⁴, R⁵, and R⁶ are selected such that the co-macromonomer of formula (B-2) has at least 6 silicon atoms per molecule. Alternatively, R⁴, R⁵, and R⁶ are selected such that the unit has at least 5 silicon atoms, alternatively at least 6 silicon atoms, alternatively 6 to 20 silicon atoms, alternatively 7 to 19 silicon atoms, alternatively 8 to 18 silicon atoms, alternatively 9 to 17 silicon atoms, and alternatively 10 to 16 silicon atoms, per molecule.

In formula (B-2), each R is a monovalent hydrocarbon group of 1 to 12 carbon atoms. The monovalent hydrocarbon group for R may be an alkyl group, such as an alkyl group of 1 to 6 carbon atoms. Alternatively, the alkyl groups may have 1 to 3 carbon atoms, alternatively 1 to 2 carbon atoms. Alternatively, each R group may be methyl.

In formula (B-2), each D is independently selected from the group consisting of an oxygen atom, a (poly)alkylene oxide group of 1 to 12 units, and a divalent hydrocarbon group of 2 to 4 carbon atoms.

The divalent hydrocarbon group for D may be exemplified by an alkylene group such as ethylene, propylene, or butylene; an arylene group such as phenylene, or an alkylarylene group such as:

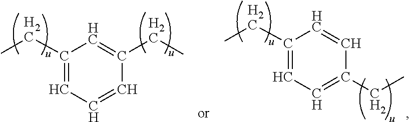

where each subscript u is independently 1 to 6, alternatively 1 to 2. Alternatively, the divalent hydrocarbon group for D may be alkylene, and alternatively the divalent hydrocarbon group for D may be ethylene.

The (poly)alkylene oxide group for D may have 2 to 4 carbon atoms per unit, e.g., have formula D⁵(OD⁶)_{v′}—OR, where D⁵ is an alkylene group of 2 to 4 carbon atoms, D⁶ is an alkylene group of 2 to 4 carbon atoms, R is as described above, and subscript v′ is 0 to 12. Alternatively subscript v′ may be 0 or 1. Alternatively, subscript v′ may be 0. Examples of (poly)alkylene oxide groups include ethyleneoxide-propyleneoxide.

Alternatively, each D may be selected from an oxygen atom and a divalent hydrocarbon group. Alternatively, each divalent hydrocarbon group for D may be an alkylene group such as ethylene. Alternatively, each D may be oxygen. Alternatively, some instances of D may be oxygen and other instances of D may be alkylene, e.g., ethylene, in the same unit.

Alternatively, formula (B-2) may comprise formula (B-2-1):

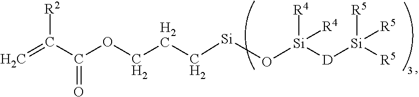

where R², R⁴, and R⁵ are as described above.

Alternatively, formula (B-2) may comprise formula (B-2-2):

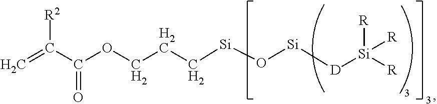

where R², D, and R are as described above.

Alternatively formula (R-2) may comprise formula (R-2-3);

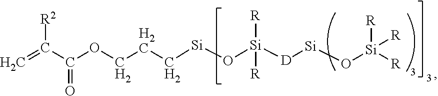

where R², D, and R are as described above.

Alternatively, formula (B-2) may comprise a co-macromonomer selected from the group consisting of: 3-(5-((1,1,1,3,5,5,5-heptamethyltrisiloxan-3-yl)oxy)-1,1,1,3,7,9,9,9-octamethyl-3,7-bis((trimethylsilyl)oxy)pentasiloxan-5-yl)propyl methacrylate of formula

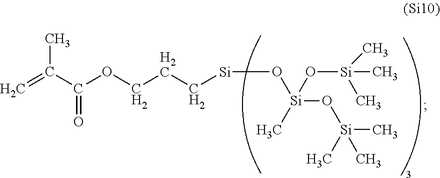

3-(1,5-bis(2-(1,1,1,5,5,5-hexamethyl-3-((trimethylsilyl)oxy)trisiloxan-3-yl)ethyl)-3-(((2-(1,1,1,5,5,5-hexamethyl-3-((trimethylsilyl)oxy)trisiloxan-3-yl)ethyl)dimethylsilyl)oxy)-1,1,5,5-tetramethyltrisiloxan-3-yl)propyl methacrylate, which has formula

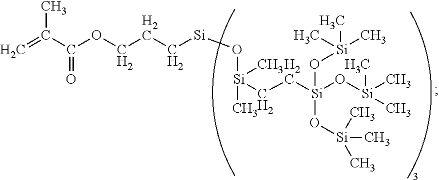

and a combination thereof. The co-macromonomer of formula (B-2) as described and exemplified above may be prepared by known methods, such as those disclosed in PCT Publication WO2020142388 and U.S. Pat. No. 6,420,504. The amount of starting material (B) may be 0 to 26%, alternatively 0 to 17%, based on combined weights of starting materials (A), (B), (C), (D), and (E) used for emulsion polymerization.

Starting material (A) the silicone-(meth)acrylate macromonomer, and starting material (B) the silicone-(meth)acrylate co-macromonomer are used in the following amounts when making the copolymer: starting material (A) is used in an amount of >25 weight % to 100 weight %, based on combined weights of starting materials (A) and (B); and starting material (B) is used in an amount of 0 to <75 weight %, based on combined weights of starting materials (A) and (B). Alternatively, starting material (A) may be used in an amount >25%, alternatively at least 40%, alternatively at least 50%, alternatively at least 63%, and alternatively at least 75%, based on combined weights of starting materials (A) and (B); while at the same time the amount of starting material (A) may be up to 100%, alternatively up to 99%. Alternatively up to 95%, alternatively up to 75%, alternatively up to 63%, alternatively up to 50%, and alternatively up to 40%, on the same basis. Alternatively, the amount of starting material (A) may be 100%, and the amount of starting material (B) may be 0. Alternatively, starting material (B) may be present, and the amount of starting material (B) may be >0%, alternatively at least 1%, alternatively up to 5%, alternatively up to 10%, alternatively up to 15%, alternatively up to 20%, and alternatively at least 25%; while at the same time the amount of starting material (B) may be up to 60%, alternatively up to 50%, alternatively up to 37%, and alternatively up to 25%, on the same basis.

The starting materials used to make the copolymer (and the copolymer made as described herein) may optionally be free of crosslinkable groups. For example, the starting materials that copolymerize in step 1) of the method described herein may be free of crosslinkable (meth)acrylate monomers such as organic (meth)acrylate monomers having crosslinkable groups. For example, the starting materials used in step 1) may be free of crosslinkable (meth)acrylate monomers such organic (meth)acrylate monomers having crosslinkable groups as (2-acetoacetoxy)ethyl methacrylate, hydroxybutyl (meth)acrylate, hydroxyethyl (meth)acrylate, hydroxyethylcaprolactone (meth)acrylate, hydroxypropyl (meth)acrylate, ureido (meth)acrylate, glycidyl (meth)acrylate (GMA), and poly(alkylene glycol) (meth)acrylate macromonomers such as poly(ethylene glycol) mono-(meth)acrylate (PEGMA) and poly(ethylene glycol) di(meth)acrylate. The starting materials used in step 1) may be free of organosilyl monomers having crosslinkable groups, such as alkenyltrialkoxysilanes (e.g., 3-(trimethoxysilyl)propyl (meth)acrylate, vinyltriethoxysilane and vinyltrimethoxysilane).

Starting material (A), and when present starting material (B), are copolymerized in the presence of an additional starting material. The additional starting material comprises (C) the initiator. Alternatively, the starting materials that copolymerize in step 1) may consist of starting materials (A) the macromonomer, and (C) the initiator, and when present, (B) the co-macromonomer and/or (H) the chain transfer agent. Alternatively, the starting materials used in step 1) may consist essentially of, or may consist of, (A) the macromonomer, (C) the initiator, (D) the surfactant, and (E) the water, and when present one or more of (B) the co-macromonomer, (H) the chain transfer agent, (I) the manganese ion source, and (J) the phenolic compound, and these starting materials are described further below.

Starting material (C), an initiator, is also added in step 1) described above. Suitable initiators include azo compounds and peroxide compounds. For example, the azo compound may be an aliphatic azo compound such as 1-t-amylazo-1-cyanocyclohexane, azo-bis-isobutyronitrile and 1-t-butylazo-cyanocyclohexane, 2,2′-azo-bis-(2-methyl) butyronitrile, 2,2′-azobis(2-methylpropionitrile), 2,2′-azobis(2-methylpropionamidine) dihydrochloride, 2,2′-azobis(cyanovaleric acid), or a combination of two or more thereof. Azo compounds are known in the art and are commercially available, e.g., under the tradename VAZO™ WSP from The Chemours Company of Wilmington, Delaware, USA. The peroxide compound may be a peroxide or a hydroperoxide, such as t-butylperoctoate, t-butyl perbenzoate, dicumyl peroxide, di-t-butyl peroxide, t-butyl hydroperoxide, cumene hydroperoxide, di-t-amyl peroxide and combinations of two or more thereof. Additionally, di-peroxide initiators may be used alone or in combination with other initiators. Such di-peroxide initiators include, but are not limited to, 1,4-bis-(t-butyl peroxycarbo)cyclohexane, 1,2-di(t-butyl peroxy)cyclohexane, and 2,5-di(t-butyl peroxy)-3-hexyne. Suitable peroxide compounds are known in the art and are commercially available from various sources, such as Sigma-Aldrich, Inc. Alternatively, the initiator may comprise isoascorbic acid, which is also available from Sigma-Aldrich, Inc.

An initiator may be used alone as starting material (C). Alternatively, starting material (C) may be a redox pair, which comprises an initiator as the oxidizing component and a reducing component. Alternatively, a redox pair including isoascorbic acid and an organic hydroperoxide such as t-amyl hydroperoxide or t-butyl hydroperoxide may be used as starting material (C). Examples of suitable initiators and/or redox pairs for starting material (C) are disclosed in U.S. Pat. No. 6,576,051 to Bardman et al., beginning at col. 11, line 16. How the initiator is added depends on various factors including whether the initiator is water soluble and the type of initiator (e.g., whether a thermal initiator or a redox pair is used). Typically, when a thermal initiator is used, all the initiator is added at once at the beginning of step 1). Alternatively, when a redox pair is used, it may be metered in over time.

Alternatively, the initiator may optionally further comprise Iron (II) sulfate heptahydrate, Potassium persulfate, or a combination thereof. The initiator (C) may be used in an amount sufficient to provide 0.01% to 3%, alternatively 0.1% to 1.5%, based on weight of the silicone-(meth)acrylate copolymer. Alternatively, the initiator may be used in an amount of 0.15% to 0.23%, based on combined weights of starting materials (A), (B), (C), (D), and (E) used in the emulsion polymerization.

Starting material (D) is a surfactant. The surfactant may be selected from the group consisting of (D-1) a cationic surfactant, (D-2) a nonionic surfactant, and (D-3) a combination of both the cationic surfactant and the nonionic surfactant. Cationic surfactants useful herein include compounds containing quaternary ammonium hydrophilic moieties in the molecule which are positively charged, such as quaternary ammonium salts, which may be represented by formula (D-1-1): R¹²R¹³R¹⁴R¹⁵N⁺X′— where R¹² to R¹⁵ are alkyl groups containing 1-30 carbon atoms, or alkyl groups derived from tallow, coconut oil, or soy; and X′ is a halogen, e.g., chlorine or bromine. Alternatively, the quaternary ammonium compounds may be alkyl trimethylammonium and dialkyldimethylammonium halides, or acetates, having at least 8 carbon atoms in each alkyl substituent. Dialkyl dimethyl ammonium salts can be used and are represented by formula (D-1-2): R¹⁶R¹⁷N⁺(CH₃)₂X′— where R¹⁶ and R¹⁷ are alkyl groups containing 12-30 carbon atoms or alkyl groups derived from tallow, coconut oil, or soy; and X′ is halogen. Monoalkyl trimethyl ammonium salts can be used and are represented by formula (D-1-3): R¹⁸N⁺(CH₃)₃X″— where R¹⁸ is an alkyl group containing 12-30 carbon atoms or an alkyl group derived from tallow, coconut oil, or soy; and X″ is halogen or acetate.

Representative quaternary ammonium halide salts are dodecyltrimethyl ammonium chloride/lauryltrimethyl ammonium chloride (LTAC), cetyltrimethyl ammonium chloride (CTAC), hexadecyltrimethyl ammonium chloride, didodecyldimethyl ammonium bromide, dihexadecyldimethyl ammonium chloride, dihexadecyldimethyl ammonium bromide, dioctadecyldimethyl ammonium chloride, dieicosyldimethyl ammonium chloride, and didocosyldimethyl ammonium chloride. These quaternary ammonium salts are commercially available under trademarks such as ADOGEN™, ARQUAD™, TOMAH™, and VARIQUAT™.

Other suitable cationic surfactants which can be used include fatty acid amines and amides and their salts and derivatives, such as aliphatic fatty amines and their derivatives. Such cationic surfactants that are commercially available include compositions sold under the names ARQUAD™ T27 W, ARQUAD™ 16-29, by Akzo Nobel Chemicals Inc., Chicago, Illinois; and Ammonyx Cetac-30 by the Stepan Company, Northfield, Illinois, USA.

The amount of (D-1) the cationic surfactant may be 0.1% to 5%, based on weight of starting material (F) the silicone-(meth)acrylate copolymer in the aqueous emulsion. Alternatively, the amount of cationic surfactant may be at least 0.1%, alternatively at least 0.2%, alternatively at least 0.3%, alternatively at least 0.4%, alternatively at least 0.5%; while at the same time the amount of cationic surfactant may be up to 5%, alternatively up to 4%, alternatively up to 3%, alternatively up to 2%, alternatively up to 1%, on the same basis. Alternatively, the amount of cationic surfactant may be 0.2% to 4%, alternatively 0.3% to 3%, alternatively 0.4% to 2.5%, and alternatively 0.5% to 2%; on the same basis.

Starting material (D-2) is a nonionic surfactant. Some suitable nonionic surfactants which can be used include polyoxyethylene alkyl ethers, polyoxyethylene alkyl phenyl ethers, alkylglucosides, polyoxyethylene fatty acid esters, sorbitan fatty acid esters, and polyoxyethylene sorbitan fatty acid esters. Nonionic surfactants which are commercially available include compositions such as (i) 2,6,8-trimethyl-4-nonyl polyoxyethylene ether sold under the names TERGITOL™ TMN-6 and TERGITOL™ TMN-10; (ii) the C11-15 secondary alkyl polyoxyethylene ethers sold under the names TERGITOL™ 15-S-7, TERGITOL™ 15-S-9, TERGITOL™ 15-S-15, TERGITOL™ 15-S-30, and TERGITOL™ 15-S-40, by the Dow Chemical Company, of Midland, Michigan, USA; octylphenyl polyoxyethylene (40) ether sold under the name TRITON™ X405 by the Dow Chemical Company; (iii) nonylphenyl polyoxyethylene (10) ether sold under the name MAKON™ 10 by the Stepan Company; (iv) ethoxylated alcohols sold under the name Trycol 5953 by Henkel Corp./Emery Group, of Cincinnati, Ohio, USA; (v) ethoxylated alcohols sold under the name BRIJ™ L23 and BRIJ™ L4 by Croda Inc. of Edison, New Jersey, USA, (vi) alkyl-oxo alcohol polyglycol ethers such as GENAPOL™ UD 050, and GENAPOL™ UD110, (vii) alkyl polyethylene glycol ether based on C10-Guerbet alcohol and ethylene oxide such as LUTENSOL™ XP 79.

Suitable nonionic surfactants also include poly(oxyethylene)-poly(oxypropylene)-poly(oxyethylene) tri-block copolymers. Poly(oxyethylene)-poly(oxypropylene)-poly(oxyethylene) tri-block copolymers are also commonly known as Poloxamers. They are nonionic triblock copolymers composed of a central hydrophobic chain of polyoxypropylene (poly(propylene oxide)) flanked by two hydrophilic chains of polyoxyethylene (poly(ethylene oxide)). Poly(oxyethylene)-poly(oxypropylene)-poly(oxyethylene) tri-block copolymers are commercially available from BASF of Florham Park, New Jersey, USA, and are sold under the tradename PLURONIC™, such as PLURONIC™ L61, L62, L64, L81, P84.

Other suitable nonionic surfactants include polyoxyethylene alkyl ethers, polyoxyethylene alkylphenol ethers, polyoxyethylene lauryl ethers, polyoxyethylene sorbitan monooleates, polyoxyethylene alkyl esters, polyoxyethylene sorbitan alkyl esters, polyethylene glycol (such as polyethylene glycol having 23 ethylene-oxide units), polypropylene glycol, diethylene glycol, ethoxylated trimethylnonanols, and polyoxyalkylene glycol modified polysiloxane surfactants. Commercially available nonionic surfactants which can be used include compositions such as 2,6,8-trimethyl-4-nonyloxy polyethylene oxyethanols (6EO) and (10EO) sold under the trademarks TERGITOL™ TMN-6 and TERGITOL™ TMN-10; alkyleneoxy polyethylene oxyethanol (C₁₁₋₁₅ secondary alcohol ethoxylates 7EO, 9EO, and 15EO) sold under the trademarks TERGITOL™ 15-S-7, TERGITOL™ 15-S-9, TERGITOL™ 15-S-15; other C11-15 secondary alcohol ethoxylates sold under the trademarks TERGITOL™ 15-S-12, 15-S-20, 15-S-30, 15-S-40; octylphenoxy polyethoxy ethanol (40EO) sold under the trademark TRITON™ X-405; and alcohol ethoxylates with tradename ECOSURF™ EH, such as ECOSURF™ EH-40. All of these surfactants are sold by the Dow Chemical Company.

Other useful commercial nonionic surfactants are nonylphenoxy polyethoxy ethanol (10EO) sold under the trademark MAKON™ 10 by Stepan Company; polyoxyethylene 23 lauryl ether (Laureth-23) sold commercially by Sigma Aldrich, Inc. of St. Louis, Missouri, USA; and RENEX™ 30, a polyoxyethylene ether alcohol available from Fisher Scientific.

Starting material (D-2) the nonionic surfactant may be delivered in a dilution, and the amount used may be sufficient to provide 0.1% to 10% of the surfactant, based on weight of starting material (F) the silicone-(meth)acrylate copolymer in the aqueous emulsion. Alternatively, the amount of nonionic surfactant may be at least 0.1%, alternatively at least 0.2%, alternatively at least 0.3%, alternatively at least 0.4%, alternatively at least 0.5%, alternatively at least 1%, alternatively at least 2%, alternatively at least 3%, alternatively at least 4%; while at the same time the amount of nonionic surfactant may be up to 10%, alternatively up to 9%, alternatively up to 8%, alternatively up to 7%, alternatively up to 5%, alternatively up to 4%, alternatively up to 3%, alternatively up to 2%, alternatively up to 1%, on the same basis. Alternatively, the amount of nonionic surfactant may be 1% to 10%, alternatively 2% to 10%, alternatively 3 to 10%, alternatively 5% to 9%, alternatively 6% to 8%, and alternatively 7% %; on the same basis. Alternatively, starting materials (D-1) the cationic surfactant and (D-2) the nonionic surfactant may be present in combined amounts≤10%, based on weight of starting material (F) the silicone-(meth)acrylate copolymer in the aqueous emulsion. Alternatively, (D) the surfactant may be used in an amount of 2% to 3.5%, based on combined weights of starting materials (A), (B), (C), (D), and (E) used in the emulsion polymerization.

Starting material (E) is water. The water is not generally limited, for example, the water may be processed or unprocessed. Examples of processes that may be used for purifying the water include distilling, filtering, deionizing, and combinations of two or more thereof, such that the water may be deionized, distilled, and/or filtered. Alternatively, the water may be unprocessed (e.g., may be tap water, i.e., provided by a municipal water system or well water, used without further purification). The amount of water is sufficient to form an aqueous emulsion for emulsion polymerization in step 1) of the process described above. Additional water may be added after step 1). For example, the aqueous emulsion prepared as described above may be diluted with additional water to achieve a desired amount of starting materials before treating a leather substrate with the resulting leather treatment composition. The water may be added in an amount of 20% to 97%, alternatively 30% to 90%, alternatively 40% to 80%, alternatively 50% to 97%, alternatively 50% to 90%, and alternatively 60% to 80%; based on combined weights of all starting materials in step 1). Alternatively, the water may be added in an amount of at least 20%, alternatively at least 30%, alternatively at least 40%, alternatively at least 50%, and alternatively at least 60%; while at the same time the amount of water may be up to 97%, alternatively up to 96%, alternatively up to 95%, and alternatively up to 80%, on the same basis. Alternatively, the amount of water may be 54% to 82%, based on combined weights of starting materials (A), (B), (C), (D), and (E) used in the emulsion polymerization to prepare (F), the silicone-(meth)acrylate copolymer.

The silicone-(meth)acrylate copolymer, (F), may be prepared by emulsion polymerization of starting materials comprising (A) the macromonomer and (C) the initiator (and optionally (B) the co-macromonomer) described above. Alternatively, the silicone-(meth)acrylate copolymer may be a reaction product of starting materials consisting essentially of starting materials (A) the macromonomer and (C) the initiator (and when present, (B) the co-macromonomer and/or (H) the chain transfer agent). Alternatively, the silicone-(meth)acrylate copolymer is a reaction product of starting materials consisting of starting materials (A) and (C), (and, when present, (B) and/or (H)). Without wishing to be bound by theory, it is thought that none of starting materials (D) the surfactant and (E) the water copolymerize with starting materials (A) and (C), (and when present (B) and/or (H)), but that starting materials (D) and (E) merely serve as a vehicle for copolymerization. However, nothing herein shall exclude the possibility that a portion of one or more of starting materials (D) and/or (E), or any other starting material added during the method, may participate in the copolymerization reaction of starting materials comprising (A) and (C), and any optional starting materials (i.e., (B) and/or (H)), when present.

The silicone-(meth)acrylate copolymer comprises unit formula (F-1):

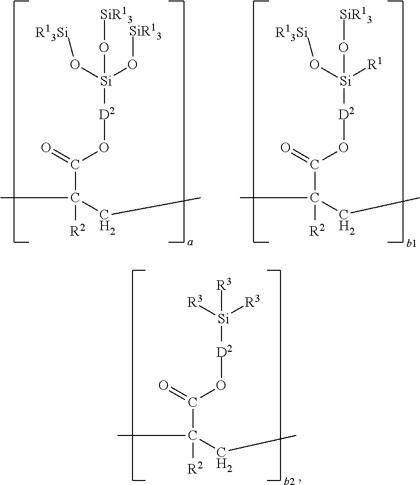

where each R¹ is an independently selected monovalent hydrocarbon group of 1 to 12 carbon atoms; each D² is independently a divalent hydrocarbon group of 2 to 12 carbon atoms; and each R² is independently selected from the group consisting of H and methyl; each R³ is a group of formula OSi(R⁴)₃; where each R⁴ is independently selected from the group consisting of R and DSi(R⁵)₃, where each R is an independently selected monovalent hydrocarbon group of 1 to 12 carbon atoms, and each D is independently selected from the group consisting of an oxygen atom, a (poly)alkylene oxide group of 1 to 12 units, and a divalent hydrocarbon group of 2 to 4 carbon atoms; each R⁵ is independently selected from the group consisting of R and DSi(R⁶)₃; where each R⁶ is independently selected from the group consisting of R and DSiR₃; with the proviso that R⁴, R⁵, and R⁶ are selected such that the silicone-(meth)acrylate co-macromonomer unit with subscript b2 has at least 5 silicon atoms; subscripts a, b1, and b2 represent weight fractions of units in the copolymer, and subscripts a, b1, and b2 have values such that 0.25<a≤1; and 0≤(b1+b2)<0.75; and the silicone-(meth)acrylate copolymer further comprises a terminal moiety. In the unit formula (F-1), R¹, R², R³, R⁴, R⁵, R⁶, R, D, and D² are as described and exemplified above for formulas (A-1), (B-1) and (B-2). Alternatively, in the unit formula (F-1) for the silicone-(meth)acrylate copolymer, each R¹ may be methyl, each R² may be methyl, each D² may be propylene, each R³ may be the group of formula OSi(R⁴)₃; where each R⁴ is independently selected from the group consisting of R and OSi(R⁵)₃, where each R is methyl; each R⁵ is independently selected from the group consisting of R and OSi(R⁶)₃; where each R⁶ is independently selected from the group consisting of R and OSiR₃; with the proviso that R⁴, R⁵, and R⁶ are selected such that the silicone-(meth)acrylate co-macromonomer 10 to 16 silicon atoms per molecule. Alternatively, subscript a may have a value such that 0.50≤a≤1, alternatively 0.63≤a≤1, alternatively 0.75≤a≤1, and alternatively a=1. Alternatively, subscript b1 may have a value such that 0≤b1<0.75, alternatively 0≤b1≤0.5, alternatively 0≤b1<0.25, and alternatively b1=0. Alternatively, subscript b2 may have a value such that 0≤b2<0.75, alternatively 0.01≤b2≤0.5, alternatively 0.05≤b1<0.25, and alternatively b1=0.25.

The silicone-(meth)acrylate copolymer prepared as described above may have a weight average molecular weight measured by GPC of >181,000 g/mol. Alternatively, silicone-(meth)acrylate copolymer may have a weight average molecular weight measured by GPC of at least 200,000 g/mol; alternatively at least 210,000 g/mol; alternatively at least 212,000 g/mol; alternatively at least 225,000 g/mol; alternatively at least 230,000 g/mol; and alternatively at least 234,000 g/mol; while at the same time, weight average molecular weight may be up to 2,000,000 g/mol; alternatively up to 1,000,000 g/mol; alternatively up to 950,000 g/mol; alternatively up to 925,000 g/mol; alternatively up to 912,000 g/mol, alternatively up to 900,000 g/mol, alternatively up to 850,000 g/mol; alternatively up to 800,000 g/mol; and alternatively up to 750,000 g/mol; and alternatively up to 721,000 g/mol. Alternatively, the silicone-(meth)acrylate copolymer may have a weight average molecular weight of 212,000 g/mol to 912,000 g/mol, measured by GPC. The samples for GPC analysis may be prepared in THF eluent at concentration 10 mg/mL copolymer. The solution may be shaken on a flat-bed shaker at ambient temperature for 2 hours. The solution may then be filtered through a 0.45 m PTFE syringe filter prior to injection. A Waters e2695 LC pump and autosampler, equipped with two 5 um Agilent PLG gel Mixed C columns in series and Shodex RI501 differential refractive index detector was used to analyze the samples. The instrument was equilibrated for 30 min at 1 mL/min and samples were run at 1 mL/min. Agilent GPC software Cirrus version 3.3 may be used for data collection and for data reduction. A total of 16 polystyrene linear narrow molecular weight standards from Agilent having Mp values from 3750 to 0.58 kg/mol may be used for molecular weight calibration. A 3rd order polynomial was used for calibration curve fitting. Thus, all molecular weight averages, distributions and references to molecular weight provided in this report are polystyrene equivalent values.

Starting material (G) is a silicone polyether (SPE) (which differs from D-2) the nonionic surfactant used herein). The silicone polyether may have a rake type structure wherein the polyoxyethylene or polyoxyethylene-polyoxypropylene copolymeric units are grafted onto the siloxane backbone, or the SPE can have an ABA block copolymeric structure wherein A represents the polyether portion and B the siloxane portion of an ABA structure. Suitable SPE's include DOWSIL™ OFX-5329 Fluid and with tradename DOWSIL™ 67 Additive from Dow Silicones Corporation of Midland, Michigan, USA. Such silicone polyethers are known in the art, and have been described, for example, in U.S. Pat. No. 4,122,029 to Gee et al., U.S. Pat. No. 5,387,417 to Rentsch, and U.S. Pat. No. 5,811,487 to Schulz et al. The silicone polyether may be added before or during step 1) of the emulsion polymerization method described above. Alternatively, the silicone polyether may be added to the leather treatment composition after formation of the aqueous emulsion, e.g., by mixing.

The exact amount of (G) the silicone polyether depends on various factors including the type and amount of (F) silicone-(meth)acrylate copolymer formed in step 1) and the leather (e.g., crust leather or base-coated leather) to be treated, however, the weight of (G) the silicone polyether may be sufficient to provide 0 to 2%, alternatively >0 to 2%, alternatively 0.05% to 2%, and alternatively 0.05% to 1%, based on combined weights of all starting materials used to make the leather treatment composition.

An additional starting material that may be added in step 1) of the method described above comprises (H) a chain transfer agent. Suitable chain transfer agents include mercaptans such as alkyl mercaptans, e.g., n-octyl mercaptan, n-dodecyl mercaptan, dodecyl mercaptan (dodecane thiol), and/or 2,2-dimethyldecyl mercaptan. Alternatively, the chain transfer agent may be water soluble, such as mercaptoacetic acid and/or 2-mercaptoethanol. Suitable chain transfer agents are known in the art and have been disclosed, for example, in “Radical Polymerization in Industry” by Peter Nesvadba, Performance Chemical Research, GASF Schweiz AG, Basel, Switzerland, Encyclopedia of Radicals in Chemistry, Biology and Materials, Online© 2012 John Wiley & Sons, Ltd.

Starting material (H) is optional and may be added in an amount of 0 to 1%, based on combined weights of starting material (A), and when present starting material (B). Alternatively, (H) the chain transfer agent may be used in an amount of 0.5% to 0.6% on the same basis.

Starting material (I) is an optional manganese ion source, which may be a manganese (II) compound. Suitable manganese compounds include manganese (II) acetate, manganese (II) nitrite, manganese (II) propionate, manganese (II) oxide, manganese (II) hydroxide, manganese (II) chloride, manganese (II) phosphate, manganese (II) perchlorate, hydrates thereof (e.g., manganese (II) acetate tetrahydrate) and combinations thereof. Alternatively, the manganese ion source may comprise manganese (II) acetate or manganese (II) acetate tetrahydrate, or a combination thereof. Suitable manganese ion sources are commercially available from Millipore Sigma of St. Louis, Missouri, USA, Fisher Scientific of Waltham, Massachusetts, USA, and City Chemical LLC of Connecticut, USA. The amount of manganese ion source depends on various factors including the selections and amounts of other starting materials used, however the amount may be 0.1 ppm to 5,000 ppm based on combined weights of starting material (A), and when present starting material (B). Alternatively, the amount of the manganese ion source may be >0 ppm, alternatively at least 0.5 ppm, alternatively at least 1 ppm, alternatively at least 1.5; while at the same time, the amount of manganese ion source may be up to 10 ppm, alternatively up to 5 ppm, alternatively up to 4 ppm, and alternatively up to 3 ppm, and alternatively up to 2 ppm, based on combined weights of all starting materials in the leather treatment composition. Alternatively, the amount of manganese ion source may be 0.0004% to 0.004%, based on combined weights of starting materials (A), (B), (C), (D), and (E) used in the emulsion polymerization.

Starting material (J) is an optional phenolic compound. Suitable phenolic compounds include hydroquinone (HQ), 2-methylhydroquinone, 2-t-butylhydroquinone, dihydroxybenzene (catechol), 4-di-t-butyl dihydroxybenzene (4-di-t-butyl catechol), resorcinol, dihydroxyxylene, methoxyphenols such as guaiacol, p-methoxyphenol (also called methyl ether of hydroquinone or MeHQ), tert-butyl hydroquinone (tBuHQ), pyrogallol, methylpyrogallol, cresol, phenol, xylenols, butylated hydroxyl toluene, N-nitroso phenylhydroxylamine, butylated hydroxy anisole, and combinations thereof. Alternatively, the phenolic compound may be selected from the group consisting of HQ, MeHQ, tBuHQ, and a combination of two or more thereof. Suitable phenolic compounds are commercially available, e.g., from Millipore Sigma of St. Louis, Missouri, USA. The amount of phenolic compound source depends on various factors including the selections and amounts of other starting materials used, however the amount may be 5 ppm to 5,000 ppm based on combined weights of starting material (A) and when present starting material (B). Alternatively, the amount of the phenolic compound may be at least 5 ppm, alternatively at least 50 ppm, alternatively at least 100 ppm, alternatively at least 150 ppm; while at the same time, the amount of phenolic compound may be up to 500 ppm, alternatively up to 400 ppm, alternatively up to 350 ppm, and alternatively up to 320 ppm, based on combined weights of all starting materials in the leather treatment composition. Alternatively, the amount of phenolic compound may be 0.009% to 0.014%, based on combined weights of starting materials (A), (B), (C), (D), and (E) used in the emulsion polymerization.

Alternatively, another inhibitor may be used in addition to, or instead of, (I) the manganese ion source and (J) the phenolic compound described above. For example, the inhibitor may comprise, or may be, nitrobenzene; 2,2-diphenyl-1-picrylhydrazyl (DPPH); phenothiazine; N,N-diethylhydroxylamine; (2,2,6,6-tetramethylpiperidin-1-yl) oxidanyl (TEMPO); 4-hydroxy-(2,2,6,6-tetramethylpiperidin-1-yl) oxidanyl (4-hydroxy TEMPO); or a combination of two or more thereof. The amount of phenolic compound may be 0.009% to 0.015%, based on combined weights of starting materials (A), (B), (C), (D), and (E) used in the emulsion polymerization. The inhibitors described above may be added before or during step 1) of the polymerization reaction of starting material (A) and when present (B). Alternatively, the inhibitor may be added to the leather treatment composition after formation of the silicone—(meth)acrylate copolymer.

Starting material (K) is an optional biocide. The amount of biocide will vary depending on factors including the type of biocide selected and the benefit desired. However, when used, the amount of biocide may be >0% to 5% based on the combined weights of all starting materials in the leather treatment composition. Starting material (K) is exemplified by (K-1) a fungicide, (K-2) an herbicide, (K-3) a pesticide, (K-4) an antimicrobial agent, or a combination thereof. Suitable biocides are disclosed, for example, in U.S. Pat. No. 9,480,977.

The leather treatment composition may optionally further comprise starting material (M), a solvent. The solvent may be used to reduce viscosity and/or improve coalescence of binder particles to facilitate formation of a coating after the leather treatment composition is coated on the leather substrate, e.g., during drying. Suitable coalescing solvents are exemplified by alcohols, ketones, glycol esters, and glycol ethers, The coalescing solvent is exemplified by a monohydric alcohol (such as isopropanol), a glycol ether, a glycol ester, and a glycol ether ester. Suitable coalescing solvents are commercially available under the tradenames DOWANOL™, DALPAD™, CARBITOL™ and CELLOSOLVE™, from The Dow Chemical Company. Alternatively, the coalescing solvent may comprise butyl carbitol. The amount of coalescing solvent in the leather treatment composition may be up to 10%, alternatively 1% to 5%, alternatively up to 3%, alternatively up to 1%, and alternatively up to 0.1%, based on combined weights of all starting materials in the leather treatment composition. The coalescing solvent may be selected (type and amount) so that it does not detrimentally impact stability of the leather treatment composition, which has the form of an emulsion.

The leather treatment composition may optionally further comprise an amount sufficient to impart softness without significantly decreasing stain and/or oil repellency of (Q) a softening additive selected from (Q-1) an alkylpolysiloxane of formula

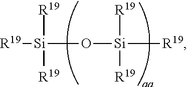

where each R¹⁹ is an independently selected monovalent saturated hydrocarbon group having 1 to 18 carbon atoms, and subscript aa has an average value of 20 to 300, or (Q-2) a combination comprising 60 to 70 weight %, based on combined weights of all starting materials in (Q-2), the combination, of (Q-1) the alkylpolysiloxane, 29 to 39 weight %, based on combined weights of all starting materials in (Q-2), the combination, of (Q-2-1) a silicone resin having a hardness ≥20 measured by Type A durometer according to JIS K 6249:2003, and 0 to 2 weight %, based on combined weights of all starting materials in (Q-2), the combination, of (Q-2-2) an amino-functional polyorganosiloxane having a functional group equivalent of 100 g/mol to 20,000 g/mol, wherein the equivalent means molecular weight of the amino-functional polyorganosiloxane per 1 mole of nitrogen atoms, and having a kinematic viscosity at 25° C. of 10 to 100,000 mm²/s measured by the method of JIS K 2283:2000. Alternatively, (Q-2-2) the amino-functional polyorganosiloxane may be present in an amount of 1% to 2%, on the same basis.

The (Q-1)alkylpolysiloxane has formula

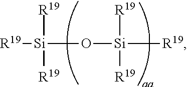

where each R¹⁹ is an independently selected monovalent saturated hydrocarbon group having 1 to 18 carbon atoms, and subscript aa has an average value of 20 to 300. The monovalent saturated hydrocarbon group for R¹⁹ may be an alkyl group, alternatively an alkyl group of 1 to 6 carbon atoms. Alternatively, the alkyl groups may have 1 to 3 carbon atoms, alternatively 1 to 2 carbon atoms. Alternatively, each R¹⁹ may be methyl. Suitable alkylpolysiloxanes, e.g., bis-trimethylsiloxy-terminated polydimethylsiloxanes, are known in the art and are commercially available, e.g., as XIAMETER™ 200 Fluids from The Dow Chemical Company of Midland, Michigan, USA.

Alternatively, (Q) the softening additive may comprise a (Q-2) combination comprising: 60 to 70 weight %, based on combined weights of all starting materials in (Q-2), the combination, of (Q-1) the alkylpolysiloxane described above, 29 to 39 weight %, based on combined weights of all starting materials in (Q-2), the combination, of (Q-2-1) a silicone resin having a hardness ≥20 measured by Type A durometer according to JIS K 6249:2003, and 1 to 2 weight %, based on combined weights of all starting materials in (Q-2), the combination, of (Q-2-2) an amino-functional polyorganosiloxane having a functional group equivalent of 100 to 20,000 g/mol, wherein the equivalent means molecular weight of the amino-functional polyorganosiloxane per 1 mole of nitrogen atoms, and having a kinematic viscosity at 25° C. of 10 to 100,000 mm²/s measured by the method of JIS K 2283:2000.

Starting material (Q) the softening additive may be delivered in a second aqueous emulsion, which comprises (Q) the softening additive, (D′) a surfactant (which may be as described above for starting material (D) the surfactant) and (E′) water (which may be as described above for starting material (E)). The second aqueous emulsion may be prepared by known methods, such as those described in U.S. Patent Application Publication 2020/0332148, by varying the types and amounts of starting materials as described herein.

When selecting starting materials to add to the aqueous emulsion prepared as described above in step 1) and the leather treatment composition formed in step 1) or step 2) described above, there may be overlap between types of starting materials because certain starting materials described herein may have more than one function. For example, the silicone polyether may function as both a nonionic surfactant and a wetting agent. When used, the silicone polyether is in addition to a different nonionic surfactant described above as starting material D). The starting materials used in aqueous emulsion and/or the leather treatment composition, may be distinct from one another.

The leather treatment composition comprises: (F) the silicone-(meth)acrylate copolymer, (D) the surfactant, and (E) the water as described above. The leather treatment may optionally further comprise an additional starting material selected from the group consisting of (G) the silicone polyether, (I) the manganese ion source, (J) the phenolic compound, (K) the biocide, (L) additional water (as described above for starting material (E)), (M) the solvent, (N) the matting additive, (O) the rheology modifier, (Q) the softening additive, and a combination of two or more of starting materials (K), (L), (M), (N), (O), and (Q).

These additional starting materials and their amounts are as described above. Furthermore, the leather treatment composition described herein may be formulated with starting materials that are fluorocarbon-free. For example, the leather treatment composition may be free of any starting material that contains a fluorine atom covalently bonded to a carbon atom. Furthermore, the leather treatment composition may be free of crosslinkers. For example, the leather treatment composition may be free of isocyanates such as reactive aliphatic polyisocyanate resins. Without wishing to be bound by theory, it is thought that such crosslinkers may be detrimental to stain repellency and/or oil repellency performance of a coating prepared from the leather treatment composition described herein.

The leather treatment composition prepared as described above may be used for treating leather. For example, a method for treating leather comprises: I) coating a surface of a leather substrate with the leather treatment composition described above, and II) heating the substrate. Step I) may be performed by any convenient method, such as padding, spraying methods such as air-atomized spray, air-assisted spray, airless spray, high volume low pressure spray, and air-assisted airless spray, knife coating, roll coating, casting, drum coating, dipping, gravure coating, bar coating, screen coating, curtain coating, brush coating, and combinations thereof the substrate with the leather treatment composition. However, the method should be sufficient to deliver a sufficient amount of (F) the silicone-(meth)acrylate copolymer sufficient to impart stain and oil resistance properties to the leather, according to the methods described below. The amount of the leather treatment composition applied on the substrate is not specifically restricted, and may have a wet coating thickness of 10 μm to 200 μm, which may correspond to a dry coating thickness of 2 μm to 70 μm. Alternatively, the application rate of the leather treatment composition may be 2 grams to 100 grams dry weight per square meter (g/m²).

The leather treatment composition may be applied on the substrate by any convenient method. For example, the leather treatment composition may be applied on the substrate by a method selected from the group consisting of spraying methods such as air-atomized spray, air-assisted spray, airless spray, high volume low pressure spray, and air-assisted airless spray, knife coating, roll coating, casting, drum coating, dipping, gravure coating, bar coating, screen coating, curtain coating, brush coating, and combinations thereof.

Step II) drying the substrate may be performed by any convenient method, such as heating, e.g., by placing the substrate in an oven. Heating the substrate may be performed to remove all or a portion of the water. The exact temperature depends on various factors including the temperature sensitivity of the type of leather selected and the desired drying time. Drying may be performed by any convenient method, such as air drying at RT or heat drying the coated substrate. The conditions for heat drying depend on various factors including the substrate selected. For example, when the substrate comprises natural leather, the heat drying temperature may be ≤120° C. Alternatively, for synthetic leather substrates, the heat drying temperature may be ≤180° C., alternatively ≤150° C. for a time sufficient to remove most or all the water. Alternatively, the temperature may be ≥100° C. to facilitate removal of the water. Alternatively, the leather treatment composition applied to the substrate may be allowed to dry at a temperature range of 20° C. to 100° C., alternatively 85° C. to 100° C. to provide a coated leather substrate having a dried coating of the leather treatment composition on at least one surface of the leather substrate. The drying and curing method can vary depending on, for example, the specific starting materials used to prepare the leather treatment composition, the amount, and the type of leather. Examples of the drying method include air drying at room temperature, hot air drying at for example 85° C., and infrared heating. The method may optionally further comprise III) repeating steps I) and II) one or more times to increase the thickness of the coating on the substrate. The thickness of the coating to be formed on the substrate is not specifically restricted.

The leather treatment method described herein may be used to provide coatings on leather, which includes natural leathers, and leather-like substances such as artificial leathers, synthetic leathers, and vinyl leathers. Examples of the leather-like substances include polyurethanes, polyvinyl chlorides, polyolefins, polyamides, and silicones branded LUXSENSE™ Silicone Synthetic Leather from Dow. Likewise, the leather treatment composition described herein can be applied to natural leather that originated from, for example a cow, a sheep, a goat, a pig, a horse, a kangaroo, a deer, an alligator, or a snake. The leather treatment composition can be applied to leather such as mineral-tanned or vegetable-tanned leather including full-grain leather, buffed or corrected-grain leather, and split leather, with or without a prior treatment with an impregnating resin mixture and with or without the application of subsequent coatings. The leather can receive a smooth or hair cell embossing prior to coating with the aqueous leather treatment composition to provide a flat surface for coating or to reduce the porosity of buffed or split leather. Alternatively, the leather treatment composition can be applied directly onto the substrate or indirectly coated over a primer layer. The coating made from the leather treatment composition of the present invention may include basecoats, color coats and topcoats comprising any of clear-coats, stains or translucent coatings, or pigmented color coats.

The resulting treated leather substrate is exemplified by automotive components (e.g., armrests, dashboards, seating, and other interior components found in vehicles); clothing such as coats, pants, flight jackets, motorcycle clothing, shoes, and gloves; luggage or handbags; accessories such as belts, wallets, and datebooks; furniture; or saddles (e.g., for bicycles or motorcycles).

### EXAMPLES

The following examples are provided to illustrate the invention to one skilled in the art and are not to be interpreted so as to limit the scope of the invention set forth in the claims. Starting materials used in these examples are summarized below in Table 1.

TABLE 1
Starting Materials

| Starting | Abbreviation or | | |
|---|---|---|---|
| Material Type | Tradename | Chemical description | Source |
| Oil/stain | Prototype | 29% solids emulsion of a | Prepared via |
| repellent | | homopolymer made from 3MT- | Reference |
| Emulsion 1 | | ALMA | Example 1 |
| Emulsion 2 | Water Repellent | 50% solids Silicone acrylic | Prepared via |
| | | copolymer | Reference |
| | | | Example 2 |
| Wetting Agent | DOWSIL ™ 67 | 3-(Polyoxyethylene)propyl | Dow |
| | additive | heptamethyltrisiloxane with | |
| | | CAS No. 67674-67-3; | |
| | | polyethylene glycol with CAS | |
| | | No. 25322-68-3; and | |
| | | polyethylene glycol monoallyl | |
| | | ether with CAS No. 27274-31-3 | |
| Isocyanate | Binder LS-3492 | 8.0-10.6% NCO content. | Dow |
| | | Reactive aliphatic | |
| | | polyisocyanate resin | |
| Substrate 1 | Leather 1 | White leather with base coat | FILK |
| Substrate 2 | Leather 2 | Crust white leather (uncoated | |
| | | leather - no basecoat) | |
| Surfactant | ECOSURF ™ EH40 | Nonionic surfactant at 75% | Dow |
| | | solids in water | |
| Macromonomer | 3MT-ALMA | 3-(1,1,1,5,5,5-hexamethyl-3- | Gelest |
| | | ((trimethylsilyl)oxy)trisiloxan- | |
| | | 3-yl)propyl methacrylate | |
| Initiator | 2,2′-Azobis(2- | 2,2′-Azobis(2- | Aldrich |
| | methylpropionamidine) | methylpropionamidine) | |
| | dihydrochloride | dihydrochloride | |
| Initiator 2 | Isoascorbic Acid | | Aldrich |
| Initiator 3 | tBHP | t-butyl hydroperoxide | Aldrich |
| Additive 1 | Iron(II) sulfate | | Aldrich |
| | heptahydrate | | |
| Additive 2 | Dodecane thiol | | Aldrich |
| inhibitors | Mn(II)/HQ/MEHQ/ | Manganese (II) acetate | Aldrich |
| | | tetrahydrate; hydroquinone; | |
| | | and 4-methoxyphenol | |
| Monomer | SA | Stearyl Acrylate | Aldrich |
| Monomer | HEMA | 2-hydroxymethacrylate | Aldrich |
| Macromonomer | Si16 | Described above | prepared as |
| | | | described in |
| | | | U.S. Pat. No. |
| | | | 6,420,504 |
| Water | water | water | Local water |
| | | | source |
| Stain 1 | Blue ball pen | | Lyreco |
| Stain 2 | Blue wax crayon | | Local shop |
| Stain 3 | Red lipstick | | Local shop |
| Stain 4 | Ketchup | | Heinz brand |
| | | | from Local |
| | | | shop |
| Stain 5 | Mustard | | Local shop |
| Stain 6 | Red Wine | | Local shop |
| Stain 7 | Cold Coffee | Soluble coffee - 2% solution in | Nescafe brand |
| | | water - Coffee at 20° C. | from |
| | | | Local shop |
| Stain 8 | Hot Coffee | Soluble coffee - 2% solution in | Nescafe brand |
| | | water - Coffee at ~75° C. | from |
| | | | Local shop |
| Cleaning | 0.5% solution of | Sodium Laureth Sulfate | BASF |
| solution | Texapon N70 | surfactant | |
| | | 70% solution | |
| Oil 1 | Kaydol | | TA2M/8A oil |
| | | | repellency kit |
| | | | from SDS |
| | | | Atlas |
| Oil 2 | Olive | | Lesieur brand |
| | | | from |
| | | | Local shop |
| Oil 3 | Rapeseed | | Vandemoortele |
| | | | brand from |
| | | | Local shop |
| Oil 4 | Sunflower | | Lesieur brand |
| | | | from |
| | | | Local shop |

In this Reference Example 1, a silicone-(meth)acrylate copolymer emulsion (Emulsion 1) was prepared as follows. 3.75 g of ECOSURF™ EH40, 39.97 g 3MT-ALMA, 0.4 g of a 2.5% water solution of 4-methoxyphenol, 0.006 g of hydroquinone and 0.12 g of 0.7 wt % water solution of Mn (II) acetate tetrahydrate and 93.83 g of water were added to a widemouth jar. A sonicator was used to make an aqueous emulsion (Fisherbrand Model 705 sonic dismembrator, amplitude 50, Power ˜62 W, for 2 min). The aqueous emulsion was then transferred to a pot and heated to 65° C. After the aqueous emulsion came to temperature, 2,2′-Azobis(2-methylpropionamidine) dihydrochloride was added (0.26 g), and the jar contents were stirred for 6 h. The jar contents were then cooled down to RT and the resulting Emulsion 1 was poured into a bottle.

In this Reference Example 2, a silicone-(meth)acrylate copolymer emulsion was prepared as follows. Stearyl acrylate was melted at 50° C. and then 1023.18 g was added to a 4000 g wide mouth jar. 870.64 g of deionized water, 51.94 g of ECOSURF™ EH40, 32.38 g of Si16, 21.57 g of HEMA, 1.08 g of dodecane thiol, 0.3 g MEHQ, 0.014 g Mn (II) and 0.1 g HQ. The mixture was heated to 50° C. and then mixed with a Lightin Labmaster at 200 rpm for 10 min and then poured into the hopper of a Niro Soavi spa model NS2002H to homogenize the starting materials at 350 bar, stirring was maintained while in the hopper. 4 L of 50° C. water was poured through the homogenizer to warm the lines before pouring in the crude emulsion. 2 more passes were completed to make the resulting monomer emulsion mix.

In this Reference Example 3, an aqueous copolymer emulsion (Emulsion 2) was prepared as follows: 3 separate solutions were prepared (A) 1.053 g 70% tBHP in 40 g of DI water (B) 1.44 g Isoascorbic acid in 40 g of water (C) 47 mg of Iron (II) sulfate heptahydrate in 15 g of water.

940 g of the monomer emulsion mix prepared as described above in Reference Example 2 was added to a 4 neck flask. 1 neck had an overhead stirrer set to 200 rpm (IKA KW20 Digital), 1 had a condenser, 1 had a temperature probe and the final had 2 feed lines connected to a dual syringe pump (KD scientific model 200). The 2 syringes were loaded with solutions A and B and then the reaction mixture was heated to 45° C. After reaching temperature, 5 g of solution C was injected into the flask and then the initiator feeds started (1 mL/min). Once the feeds were finished the reaction was cooled to room temperature to make Emulsion 2.

In this Reference Example 4, Leather Treatment Compositions were prepared and coated on leather substrates as follows: Compositions were prepared by mixing the starting materials described in Table 1 in amounts shown below in Table 2. All starting materials except the isocyanate were added to a plastic cup. The cup was placed into a dental mixer (Brand: RohChem Speedmixer Benelux/Model: DAC 150.1FV) and mixed at 2700 rpm for 1 min. The isocyanate (if used) was then added, and the sample was mixed again for 1 min at 2700 rpm. The samples were then coated onto the leather substrates by applying a 2×34μ wet coating and then cured at 80° C. in an oven (Brand: Memmert/Model: UF110 or UF110 Plus, both with forced air.)

TABLE 2
Leather Treatment Compositions

| | Emulsion 1 | Emulsion 2 | Wetting | Isocyanate | Water |
|---|---|---|---|---|---|
| Sample | (g) | (g) | agent (g) | (g) | (g) |
| 1 | 99 | 0 | 1 | 0 | 0 |
| 2 | 84 | 0 | 1 | 15 | 0 |
| 3 | 0 | 100 | 0 | 0 | 0 |
| 4 | 0 | 85 | 0 | 15 | 0 |
| 5 | 100 | 0 | 0 | 0 | 0 |
| 6 | 85 | 0 | 0 | 15 | 0 |
| 7 | 0 | 100 | 0 | 0 | 0 |
| 8 | 0 | 85 | 0 | 15 | 0 |

In this Reference Example 5, the samples in Table 2 were tested for staining on white base-coated leather and on crust leather. The staining test was performed by putting/marking the different stains on the treated leather substrate and letting them sit for 24 h at 21° C. The stained leather substrates were then treated with a 0.5% solution of Texapon N70 solution. (The Texapon N70 was supplied as a solution at 70% solids. So, it was diluted with water to obtain a solution at 0.5% solids.) The results of treating the base-coated leather samples are in Table 3, and the results of treating the crust leather samples are in Table 4. A result of 2 or higher passed the staining test. Samples with a result of lower than 2 failed the staining test.

TABLE 3
Results of stain testing on white base-coated leather

| | Sample | Sample | Sample | Sample | Sample | Sample | Sample | Sample |
|---|---|---|---|---|---|---|---|---|
| Stain type | 1 | 3 | 2 | 4 | 5 | 7 | 6 | 8 |
| 2 Blue ball pen | 5 | 4 | 3 | 4 | 4 | 2 | 3 | 2 |
| 3 Blue wax | 5 | 5 | 5 | 5 | 4 | 3 | 3 | 4 |
| crayon | | | | | | | | |
| 4 Red lipstick | 4 | 1 | 4 | 1 | 2 | 1 | 3 | 5 |
| 5 Ketchup | 5 | 5 | 5 | 5 | 4 | 5 | 4 | 5 |
| 6 Mustard | 4 | 5 | 4 | 5 | 4 | 3 | 4 | 4 |
| 7 Red Wine | 5 | 5 | 3 | 5 | 4 | 2 | 3 | 2 |
| 8 Cold Coffee | 4 | 4 | 3 | 5 | 4 | 2 | 3 | 2 |
| 9 Hot Coffee | 4 | 4 | 3 | 5 | 4 | 2 | 3 | 2 |

The results in Table 3 show that leather treatment compositions made with Emulsion 1 (i.e., samples 1 and 2, with wetting agent) provided stain resistance on coated leather for all of the stains tested. However, leather treatment compositions made with Emulsion 2 (i.e., samples 3 and 4) failed the stain resistance test for red lipstick.

The data in Table 3 also show that leather treatment compositions made with Emulsion 1 (i.e., samples 5 and 6, without wetting agent) provided stain resistance on uncoated leather for all of the stains tested. However, the leather treatment compositions made with Emulsion 2 without an isocyanate (i.e., sample 7) failed the stain resistance test for red lipstick.

Furthermore, the leather treatment compositions made with Emulsion 1 overall provided better stain resistance than the leather treatment compositions made with Emulsion 2, as shown by higher stain resistance values for 7 of stains tested on sample 5 as compared to the same stains tested on sample 7.

In this Reference Example 6, black leather samples with base coat were treated as described in Reference Example 4 were tested for oil repellency as follows: To each treated leather sample was applied drop (with a dropper ˜0.03 g) of each oil. Each drop was covered with a bottle cap and then the leather samples were put in an oven (Brand: Memmert/Model: UF110 or UF110 Plus, both with forced air) for 16 h at 52° C. The samples were then removed from the oven and left to sit at ˜21° C. for 6 h. The oil was then removed, and the test area cleaned with water and paper towels. A visual evaluation was then done with the following rating system 5/Pass—No change, 4/Pass—Light change, hardly visible, 3/Medium—Clearly visible mark, 2/Fail—Strong visible mark, 1/Fail—Coating destroyed or strongly altered. The oil repellency performance results are in Table 4, and a sample with a value of 3 or higher passed, but lower than 3 failed.

TABLE 4
Oil performance test results

| | Rating - Visual check after 16 H 52° C. + 6 H RT | | | |
|---|---|---|---|---|
| Sample | Kaydol oil | Olive oil | Rapeseed oil | Sunflower oil |
| 1 | 4 | 5 | 5 | 5 |
| 3 | 2 | 2 | 2 | 2 |
| 2 | 3 | 3 | 4 | 4 |
| 4 | 2 | 2 | 2 | 2 |

The results in Table 4 show that leather treatment compositions made with Emulsion 1 (i.e., samples 1 and 2 with wetting agent) provided oil resistance on leather for all of the oils tested. However, leather treatment compositions made with Emulsion 2 (i.e., samples 3 and 4) failed the oil resistance test for all oils tested.

### INDUSTRIAL APPLICABILITY

The leather treatment composition described herein provides good anti-stain performances when used as a topcoat on base-coated leather or as a coating on uncoated (crust) leather. This composition is efficient against ball pen, wax crayon, ketchup, mustard, red wine and cold and hot coffee. Isocyanate need not be added to the leather treatment composition to achieve good anti-stain performance. A wetting agent may be included to improve coating uniformity when the leather treatment composition is used as a topcoat on base-coated leather. However, neither isocyanate nor wetting agent are needed for coating crust leather. The leather treatment composition of this invention also provides good oil repellency for a variety of different oils.

### DEFINITIONS AND USAGE OF TERMS

All amounts, ratios, and percentages herein are by weight, unless otherwise indicated. The SUMMARY and ABSTRACT are hereby incorporated by reference. The articles, “a”, “an”, and “the” each refer to one or more, unless otherwise indicated by the context of the specification. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The symbol “<” denotes “less than”, the symbol “>” denotes “greater than”, the symbol “≤” denotes “less than or equal to”, and the symbol “≥” denotes “greater than or equal to”. The abbreviations used herein have the definitions in Table 5.

TABLE 5
Abbreviations

| Abbreviation | Definition |
|---|---|
| ° C. | degrees Celsius |
| Dow | The Dow Chemical Company of Midland, Michigan, |
| | USA |
| DP | Degree of polymerization |
| GPC | Gel permeation chromatography |
| g | gram |
| h | hour |
| kg | kilogram |
| m | meter |
| (meth)acrylate | class of compound including an acrylate, a methacrylate, |
| | or both. |
| min | minute |
| mL | milliliter |
| mol | mole |
| OEM | original equipment manufacturer |
| ppm | part per million |
| PFAS | perfluoroalkyl substance |
| PTFE | polytetrafluoroethylene |
| RPM or rpm | revolutions per minute |
| RT | room temperature of 23° C. ± 2° C. |
| THF | tetrahydrofuran |
| uL | microliter |
| um | micrometer |

1. A method for treating leather comprises:
I) applying to a surface of a leather substrate, a leather treatment composition comprising
(F) a silicone-(meth)acrylate copolymer comprising unit formula: 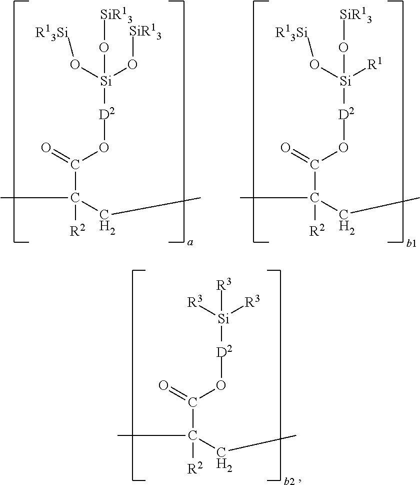
wherein
each R¹ is an independently selected monovalent hydrocarbon group of 1 to 12 carbon atoms;
each D² is an independently selected divalent hydrocarbon group of 2 to 12 carbon atoms;
each R² is independently selected from the group consisting of H and methyl;
each R³ is a group of formula OSi(R⁴)₃; wherein
each R⁴ is independently selected from the group consisting of R and DSi(R⁵)₃, wherein
each R is an independently selected monovalent hydrocarbon group of 1 to 12 carbon atoms, and
each D is independently selected from the group consisting of an oxygen atom, a (poly)alkylene oxide group of 1 to 12 units, and a divalent hydrocarbon group of 2 to 4 carbon atoms;
each R⁵ is independently selected from the group consisting of R and DSi(R⁶)₃;
each R⁶ is independently selected from the group consisting of R and DSiR₃;
with the proviso that R⁴, R⁵, and R⁶ are selected such that the silicone-(meth)acrylate co-macromonomer unit with subscript b2 has at least 5 silicon atoms;
subscripts a, b1, and b2 represent weight fractions of units in the copolymer, and
subscripts a, b1, and b2 have values such that 0.25<a≤1; and 0≤(b1+b2)<0.75, and (a+b1+b2)=1, with the proviso that the silicone-(meth)acrylate copolymer further comprises a terminal moiety; and where (F) the silicone—(meth)acrylate copolymer is a reaction product of starting materials consisting essentially of (A) a silicone-(meth)acrylate macromonomer and (C) an initiator, and when present (B) a silicone-(meth)acrylate co-macromonomer and/or (H) a chain transfer agent;
(D) a nonionic surfactant;
(E) water; and
II) drying the substrate.

2. The process of claim 1, wherein the leather treatment composition further comprises an additional starting material selected from the group consisting of a phenolic compound, a manganese ion source, a silicone polyether (that differs from (D) the nonionic surfactant) and a combination of two or more thereof.

3. The process of claim 2, where (I) the manganese ion source is present, and the manganese ion source comprises manganese (II) acetate, manganese (II) acetate tetrahydrate, or a combination thereof.

4. The process of claim 2, wherein the phenolic compound is present, and the phenolic compound is selected from the group consisting of hydroquinone, monomethyl ether of hydroquinone, tert-butylhydroquinone, and a combination of two or more thereof.

5. The process of claim 1, wherein
each R¹ is methyl,
each R² is methyl,
each D² is propylene,
subscript a=1,
subscript b1=0, and
subscript b2=0.

6. The process of claim 1, wherein the silicone-(meth)acrylate copolymer is prepared before step I) by a method comprising:
1) copolymerizing starting materials comprising
(A) a silicone-(meth)acrylate macromonomer of formula 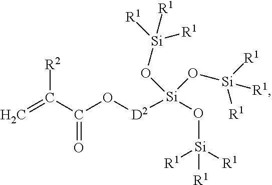
where each R¹ is an independently selected monovalent hydrocarbon group of 1 to 12 carbon atoms; D² is a divalent hydrocarbon group of 2 to 12 carbon atoms; and R² is selected from the group consisting of H and methyl;
optionally (B) a silicone-(meth)acrylate co-macromonomer, wherein (B) the silicone-(meth)acrylate co-macromonomer has a formula selected from the group consisting of formula (B-1), formula (B-2), and a combination of both formula (B-1) and formula (B-2), wherein
formula (B-1) is 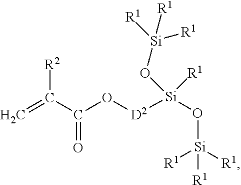
where each R¹ is an independently selected monovalent hydrocarbon group of 1 to 12 carbon atoms; D² is a divalent hydrocarbon group of 2 to 12 carbon atoms; and R² is selected from the group consisting of H and methyl;
formula (B-2) is 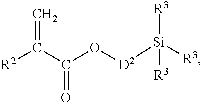
where R² is selected from the group consisting of H and methyl; D² is a divalent hydrocarbon group of 2 to 12 carbon atoms, and each R³ is a group of formula OSi(R⁴)₃; where each R⁴ is independently selected from the group consisting of R and DSi(R⁵)₃, where each R is an independently selected monovalent hydrocarbon group of 1 to 12 carbon atoms, and each D is independently selected from the group consisting of an oxygen atom, a (poly)alkylene oxide group of 1 to 12 units, and a divalent hydrocarbon group of 2 to 4 carbon atoms; each R⁵ is independently selected from the group consisting of R and DSi(R⁶)₃; where each R⁶ is independently selected from the group consisting of R and DSiR₃; with the proviso that R⁴, R⁵, and R⁶ are selected such that the silicone-(meth)acrylate co-macromonomer of formula (B-2) has at least 5 silicon atoms per molecule;
where starting material (A) is present in an amount of >25 weight % to 100 weight %, based on combined weights of starting materials (A) and (B); and
where starting material (B) is present in an amount of 0 to <75 weight %, based on combined weights of starting materials (A) and (B); and
where starting materials (A) and (B) are copolymerized in the presence of an additional starting material, wherein the additional starting material comprises
(C) an initiator;
optionally (H) a chain transfer agent;
optionally (I) a manganese ion source; and
optionally (J) a phenolic compound; and
where one of conditions (i) or (ii) is met,
where condition (i) is that step 1) further comprises adding a solvent before or during step 1), removing the solvent after forming (F) the silicone-(meth)acrylate copolymer, and forming an aqueous emulsion comprising (F) the silicone-(meth)acrylate copolymer, (D) a surfactant, and (E) water; and
where condition (ii) is that step 1) comprises an emulsion polymerization reaction; the additional starting materials further comprise (D) the surfactant and (E) the water; and
where the product of step 1) comprises an aqueous emulsion comprising (F) the silicone-(meth)acrylate copolymer, (D) the surfactant, and (E) the water; and where (F) the silicone-(meth)acrylate copolymer is a reaction product of starting materials consisting essentially of (A) the silicone-(meth)acrylate macromonomer and (C) the initiator, and when present (B) the silicone-(meth)acrylate co-macromonomer and/or (H) the chain transfer agent.

7. The process of claim 6, wherein (B) the silicone-(meth)acrylate co-macromonomer of formula (B-2) is present is present in an amount of 1 weight % to 50 weight %, based on combined weights of starting materials (A) and (B), and formula (B-2) is selected from the group consisting of 3-(5-((1,1,1,3,5,5,5-heptamethyltrisiloxan-3-yl)oxy)-1,1,1,3,7,9,9,9-octamethyl-3,7-bis((trimethylsilyl)oxy)pentasiloxan-5-yl)propyl methacrylate; 3-(1,5-bis(2-(1,1,1,5,5,5-hexamethyl-3-((trimethylsilyl)oxy)trisiloxan-3-yl)ethyl)-3-(((2-(1,1,1,5,5,5-hexamethyl-3-((trimethylsilyl)oxy)trisiloxan-3-yl)ethyl)dimethylsilyl)oxy)-1,1,5,5-tetramethyltrisiloxan-3-yl)propyl methacrylate; and a combination thereof.

8. The process of claim 6, where (I) the manganese ion source is present, and the manganese ion source comprises manganese (II) acetate, manganese (II) acetate tetrahydrate, or a combination thereof.

9. The process of claim 6, wherein the phenolic compound is present, and the phenolic compound is selected from the group consisting of hydroquinone, monomethyl ether of hydroquinone, tert-butylhydroquinone, and a combination of two or more thereof.

10. The process of claim 1, wherein the process further comprises adding (G) a silicone polyether before or during step I).

11. The process of claim 1, wherein the process further comprises adding an additional starting material selected from the group consisting of (K) a biocide, (L) additional water, (M) a solvent, (N) a matting additive, (O) a rheology modifier, (Q) a softening additive, and a combination of two or more thereof.

12. The process of claim 6, wherein starting material (A) is 3-(1,1,1,5,5,5-hexamethyl-3-((trimethylsilyl)oxy)trisiloxan-3-yl)propyl methacrylate.

13. The process of claim 12, wherein (B) the silicone-(meth)acrylate co-macromonomer of formula (B-2) is present is present in an amount of 1 weight % to 50 weight %, based on combined weights of starting materials (A) and (B), and formula (B-2) is selected from the group consisting of 3-(5-((1,1,1,3,5,5,5-heptamethyltrisiloxan-3-yl)oxy)-1,1,1,3,7,9,9,9-octamethyl-3,7-bis((trimethylsilyl)oxy)pentasiloxan-5-yl)propyl methacrylate; 3-(1,5-bis(2-(1,1,1,5,5,5-hexamethyl-3-((trimethylsilyl)oxy)trisiloxan-3-yl)ethyl)-3-(((2-(1,1,1,5,5,5-hexamethyl-3-((trimethylsilyl)oxy)trisiloxan-3-yl)ethyl)dimethylsilyl)oxy)-1,1,5,5-tetramethyltrisiloxan-3-yl)propyl methacrylate; and a combination thereof.

14. The process of claim 12, where (I) the manganese ion source is present, and the manganese ion source comprises manganese (II) acetate, manganese (II) acetate tetrahydrate, or a combination thereof.

15. The process of claim 12, wherein the phenolic compound is present, and the phenolic compound is selected from the group consisting of hydroquinone, monomethyl ether of hydroquinone, tert-butylhydroquinone, and a combination of two or more thereof.

16. The process of claim 1, wherein the leather treatment composition is free of isocyanate.

17. The process of claim 1, wherein the leather treatment composition is fluorocarbon-free.

18. The process of any one of claim 1, wherein the leather treatment composition is free of silicone polyether, and wherein the substrate is an uncoated leather.

19. The process of claim 1, wherein a silicone polyether is present in the leather treatment composition, and wherein the substrate is a base-coated leather.

20. A leather treatment composition comprising:
a silicone-(meth)acrylate copolymer comprising unit formula: 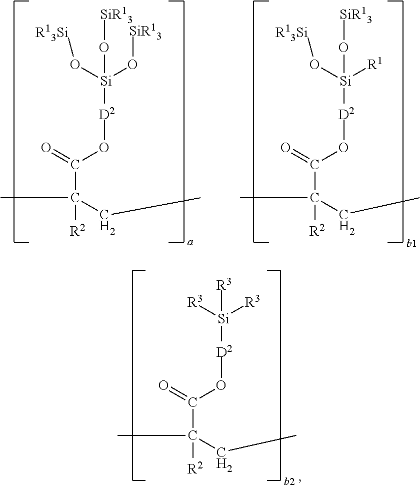
wherein
each R¹ is an independently selected monovalent hydrocarbon group of 1 to 12 carbon atoms;
each D² is an independently selected divalent hydrocarbon group of 2 to 12 carbon atoms;
each R² is independently selected from the group consisting of H and methyl;
each R³ is a group of formula OSi(R⁴)₃; wherein
each R⁴ is independently selected from the group consisting of R and DSi(R⁵)₃, wherein
each R is an independently selected monovalent hydrocarbon group of 1 to 12 carbon atoms, and
each D is independently selected from the group consisting of an oxygen atom, a (poly)alkylene oxide group of 1 to 12 units, and a divalent hydrocarbon group of 2 to 4 carbon atoms;
each R⁵ is independently selected from the group consisting of R and DSi(R⁶)₃;
each R⁶ is independently selected from the group consisting of R and DSiR₃;
with the proviso that R⁴, R⁵, and R⁶ are selected such that the silicone-(meth)acrylate co-macromonomer unit with subscript b2 has at least 5 silicon atoms;
subscripts a, b1, and b2 represent weight fractions of units in the copolymer, and subscripts a, b1, and b2 have values such that 0.25<a≤1; and 0≤(b1+b2)<0.75, and (a+b1+b2)=1, with the proviso that the silicone-(meth)acrylate copolymer further comprises a terminal moiety; and where (F) the silicone-(meth)acrylate copolymer is a reaction product of starting materials consisting essentially of (A) a silicone-(meth)acrylate macromonomer and (C) an initiator, and when present (B) a silicone-(meth)acrylate co-macromonomer and/or (H) a chain transfer agent;
a nonionic surfactant;
water; and
a silicone polyether.
